(19) United States
(12) Patent Application Publication
(10) Pub. No.: US 2003/0030344 A1
(43) Pub. Date: Feb. 13, 2003

(54) Arrangement and method for producing different output volatges with an alternating current generator

(76) Inventors: Andreas Hatz, Victoria (AU); Helmut Schultes, Victoria (AU)

Correspondence Address: Striker Striker & Stenby, 103 East Neck Road, Huntington, NY, 11743, US

(21) Appl. No.: 10/130,038

(22) PCT Filed: Sep. 20, 2001
(86) PCT No.: PCT/DE01/03601

(30) Foreign Application Priority Data
Sep. 20, 2000 (DE) 100 47 287.7

(51) Int. Cl. H02K 1/00

(52) U.S. Cl. 310/179

(57) ABSTRACT

The invention concerns an apparatus having an alternating-current generator (10) for generating various output voltages, whereby the alternating-current generator (10) comprises a rotor (12) and a stator (14) having a plurality of stator windings (16), and the stator windings (16) are configured in a certain fashion to generate an output voltage, whereby the configuration of the connections of the stator windings (16) is changeable by means of a configuration circuit (18) to generate various output voltages. The invention further concerns a method which can be carried out in advantageous fashion using the apparatus according to the invention.

The invention concerns an apparatus having an alternating-current generator for generating various output voltages, whereby the alternating-current generator comprises a rotor and a stator having a plurality of stator windings, and the stator windings are configured in a certain fashion to generate an output voltage. The invention further concerns a method for generating various output voltages with an alternating-current generator, whereby the alternating-current generator comprises a rotor and a stator having a plurality of stator windings, and the stator windings are configured in a certain fashion to generate an output voltage.

### BACKGROUND OF THE INVENTION

In generic systems for generating various output voltages, an alternator is provided, for example, the output phases of which are transmitted to a transformer. By picking off the output voltage of the transformer at different points of the transformer windings, it is possible, for example, to draw two different output voltages from the transformer. These output voltages of the transformer are then transmitted to a rectification, so that two direct voltages of different levels are ultimately present. In the case of another system for generating various output voltages, the output voltage of an alternating-current generator is first rectified and then converted to other voltages using a DC-DC converter. Although two different direct voltages can be provided using the systems described in the related art, the variability of these said systems is unsatisfactory in terms of different and, in particular, higher output requirements, for example.

### ADVANTAGES OF THE INVENTION

The invention is based on the generic apparatus in that the configuration of the connections of the stator windings is changeable by means of a configuration circuit to generate various output voltages. An adjustment can therefore be carried out by means of the configuration circuit depending on the requirements in terms of the value of the output voltage and the output power. A plurality of stable output voltage levels is therefore available.

The configuration circuit is preferably combined with a switchable rectifier stage. The different output voltage levels can be generated selectively by switching the rectifier stage.

It is particularly advantageous when a control unit is provided to control the configuration circuit and the switchable rectifier stage. Using a control unit of this type, the configuration of the connections of the stator windings and the desired output voltage level can be adjusted in variable fashion from one central point.

A stator having three phases is preferably provided. The invention is therefore usable, advantageously, in conjunction with an alternator.

It is particularly advantageous when the configuration of the three phases of the stator is changeable in such a fashion that, alternatively, a star connection or a delta connection exists. In the case of a star connection, the start points of the three phases are joined to form a single point. In the case of the delta connection, the three phases are joined in series to form a closed electric circuit. One or the other connection can be preferrable depending on the application; a variable switchover possibility is therefore particularly advantageous.

Each phase of the stator preferably comprises two stator windings. This increases the variability of the system even further, particularly in terms of output power.

It is particularly advantageous when the configuration of the connections of the stator windings of one phase is changeable in such a fashion that, alternatively, a series connection or a parallel connection exists. Depending on the requirements, therefore, either the voltages of the stator windings of one phase can be added, so that an increased output direct voltage can be ultimately provided, or a parallel connection can be achieved, so that, when voltage is lower, a greater current can potentially be carried. Pursuing this thought even further, it is also possible to provide more than two stator windings per phase, so that the variability is increased even further.

It can be advantageous when the rotor is of the coil type. The strength of the magnetic field and, ultimately, the output behavior of the apparatus can therefore be influenced by a current in the rotor coil.

It can also be advantageous, however, if the rotor is a permanent magnet. This has advantages in terms of minimal complexity of the system.

The configuration circuit preferably comprises bidirectional switching elements. This allows the alternating phases in the stator windings to be switched to the different configurations in advantageous fashion.

It can be advantageous when a bidirectional switching unit is achieved by means of two parallel thyristors. The switching behavior of thyristors can be used reliably to make the variable switching functions of the configuration circuit possible.

It is advantageous on occasion, however, when a bidirectional switching element is achieved by means of a series connection of two MOSFETs. Compared to thyristors, MOSFETs have the advantage that they operate with lower energy loss due to the lower voltage drop in the conducting direction.

The switchable rectifier stage preferably comprises thyristors and diodes. At a given polarity, the thyristors are used to rectify the positive half wave, for example, while the diodes rectify the negative half wave.

The control unit preferably monitors the phase response of the alternating-current generator. This allows the optimal switching times between the different configurations of the connections of the stator windings to be determined. This makes it possible, in particular, to minimize the response time of the system, because, for instance, a change from a star configuration to a delta configuration requires an entire electrical period during which no current can flow through the stator circuit.

It can be useful as well when the control unit monitors the output voltages. This makes it possible to react to the variable requirements for direct-voltage output. If the voltage at a special connecting point drops below a certain specified value, the desired voltage can be made available once more by changing the configuration circuit. It can be therefore ensured that the required currents and voltages are available at all times at every output terminal.

It is particularly advantageous when the configuration circuit and/or the switchable rectifier stage are achieved as an integrated circuit. When this is the case, a particularly compact apparatus is made available.

The invention is based on the generic method in that the configuration of the connections of the stator windings is changed by means of a configuration circuit to generate various output voltages. An adjustment can therefore be carried out via the configuration circuit depending on the requirements in terms of the value of the output direct voltage and the output power. A plurality of stable output voltage levels is therefore available.

The configuration circuit and a switchable rectifier stage combined with the configuration circuit are preferably controlled by a control unit. The different output voltage levels can be generated selectively by switching the rectifier stage. Using a control unit, the configuration of the connections of the stator windings and the desired output voltage level can be variably adjusted from one central point.

Preferably, three phases are generated by the stator. The invention is therefore usable, advantageously, in conjunction with an alternator.

It is particularly advantageous when the configuration of the three phases of the stator are changed in such a fashion that, alternatively, a star connection or a delta connection exists. In the case of a star connection, the start points of the three phases are joined to form a single point. In the case of the delta connection, the three phases are joined in series to form a closed electric circuit. One or the other connection can be preferrable depending on the application; a variable switchover possibility is therefore particularly advantageous

It can also be particularly advantageous when, in the case of two stator windings per phase of the stator, the configuration of the stator windings of one phase are changed in such a fashion that, alternatively, a series connection or a parallel connection exists. Depending on the requirements, therefore, the voltages of the stator windings of one phase can either be added, so that an increased output direct voltage can be ultimately provided, or a parallel connection can be achieved, so that, when voltage is lower, a greater current can potentially be carried. Pursuing this thought even further, it is also possible to provide more than two stator windings per phase, so that the variability is increased even further.

The control unit preferably monitors the phase response of the alternating-current generator. This allows the optimal switching times between the different configurations of the connections of the stator windings to be determined. This makes it possible, in particular, to minimize the response time of the system, because, for instance, a change from a star configuration to a delta configuration requires an entire electrical period during which no current can flow through the stator circuit.

It can be useful as well when the control unit monitors the output voltages. This makes it possible to react to the variable requirements for direct-voltage output. If the voltage at a special connecting point drops below a certain specified value, the desired voltage can be made available once more by changing the configuration circuit. It can be therefore ensured that the required currents and voltages are available at all times at every output terminal.

The invention is based on the surprising finding that different output voltages can be made available by means of a variable switching-over of the connections of the stator windings. This variability affects the value of the output voltages as well as the available power, whereby it is also possible in particular to react to changing requirements in variable fashion during operation.

### SUMMARY OF THE DRAWINGS

The invention will now be explained using preferred exemplary embodiments with reference to the accompanying drawings.

FIG. 1 shows a block diagram to pictorialize the invention;

FIG. 2 shows a sketched circuit diagram to pictorialize the invention; and

FIG. 3 shows a diagram to explain the different possible configurations.

### DESCRIPTION OF PREFERRED EMBODIMENTS

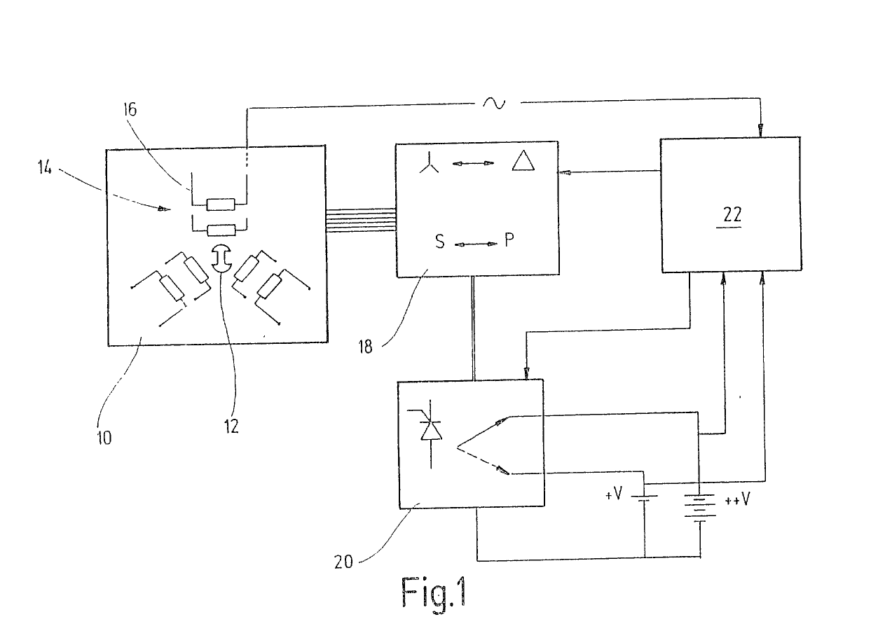

A block diagram is shown in FIG. 1 to explain the invention. An alternator 10 comprises a rotor 12 and a stator 14. The rotor 12 generates a magnetic field. The stator 14 has two windings 16 per phase, which are excited by means of the rotation of the rotor 12. The statorwindings 16 are interconnected with a configuration circuit 18. This configuration circuit is capable of switching between a delta configuration and a star configuration, for example. It is further possible to select between a series connection of stator windings and a parallel connection of stator windings. The output terminals of the configuration circuit lead to a rectifier stage 20. This rectifier stage 20 is capable of making two different output direct voltages, +V and ++V, available. Furthermore, a control unit 22 is provided, which is achieved as an electronic control unit. This control unit 22 receives, as the input signal, a phase output of the alternating-current generator 10, as well as the values of the output voltages generated by the apparatus. The control unit 22 controls the configuration circuit 18 as well as the rectifier stage 20.

The apparatus according to FIG. 1 functions as follows. The alternator 10 generates three phases of a three-phase current. This takes place by means of the rotation of the rotor 12, which generates a magnetic field, thereby inducing current in the stator windings 16 of the stator 14. Each phase of the stator 14 is outfitted with two stator windings 16, so that a total of six output voltages are transmitted by the alternating-current generator 10 to the configuration circuit 18. The configuration circuit 18 is now capable of interconnecting the phases to form a star configuration or a delta configuration, and of switching over between these configurations. Using the configuration circuit, it is further possible to switch between a series connection (S) and a parallel connection (P) of the stator windings of a phase. These switching functions of the configuration circuit 18 are controlled by the control unit 22. The output voltages of the configuration circuit 18 are transmitted to a rectifier stage 20. The voltages are rectified by this rectifier stage 20 and, finally, they are output as output voltages +V and ++V. The output voltages +V and ++V are also used as input voltages for the control unit 22, so that the control unit 22 can react in variable fashion to a change in the output voltages +V and ++V. The control unit 22 also receives a phase output from the alternator 10 as input information, so that the optimal switching times between the different configurations of the configuration circuit 18 can be determined. The reason behind this is that, e.g., a change from a star configuration to a delta configuration, or a change from the delta configuration to the star configuration lasts for an entire electrical period, which corresponds to one full rotation of the rotor 12. As a result, no current can flow in the stator circuit during this period of time.

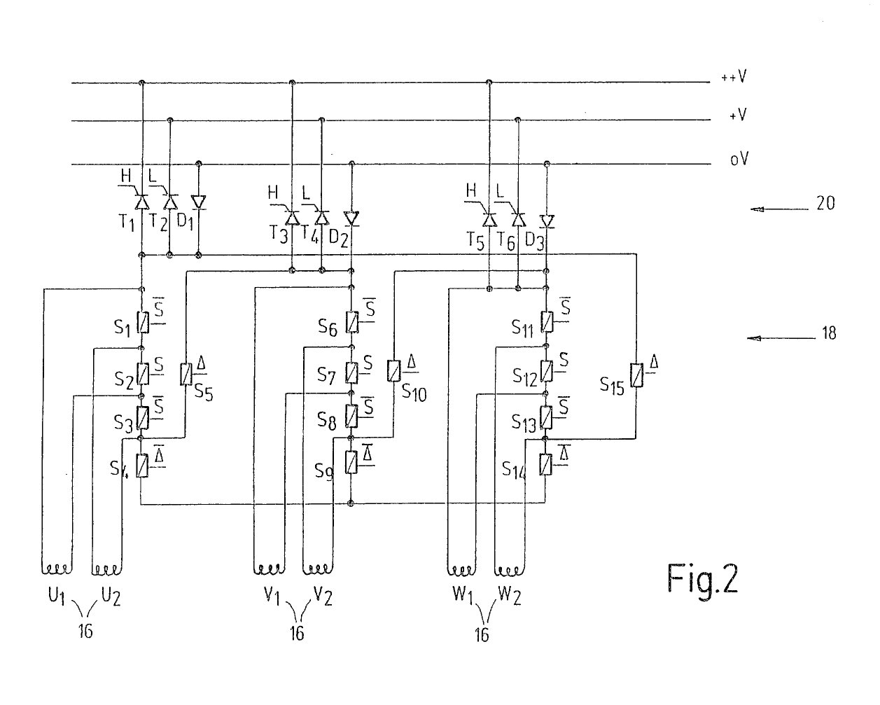

FIG. 2 shows a circuit diagram which can be used to explain particular aspects of the configuration circuit 18 and the rectifier stage 20 in detail. Three pair of stator windings 18 are shown, designated U₁, U₂ or V₁, V₂ or W₁, W₂. The configuration circuit 18 with its switches S₁, S₂, . . . , S₁₅ is also shown. The output terminals of this configuration circuit 18 lead to the rectifier stage 20 with thyristors T₁, T₂, ... T₄ and diodes D₁, D₂, D₃. The entire circuit is controlled by means of a plurality of signals that are output by the control unit 22 shown in FIG. 1. These signals are input to the switches S₁, S₂, . . . , S₁₅ or the thyristors T₁, T₂, . . . T₆. The various signals achieve the following switching functions:

Δ: Delta connection

invΔ: Star connection

S: Series connection

invS: Parallel connection

H: Output of a high output voltage ++V

L: Output of a low output voltage +V

If a delta connection is achieved, for example, the switches S₅, S₁₀, and S₁₅ are closed by means of the signal Δ, while the switches S₄, S₉, and S₁₄ are open. As a result, the three phases U, V and W are connected in series, and the delta connection is achieved. In another case, when the signal invΔ sets, the switches S₄, S₇ and S₁₄ are closed, while the switches S₅, S₁₀, and S₁₅ are open. As a result, the start points of the three phases U, V and W are joined to form a common point, achieving a star connection. If one wants to connect the stator windings of one phase in series, the signal S is output by the control unit 22. The switches S₂, S₇ and S₁₂ are closed as a result, while the switches S₁, S₃, S₆, S₈, S₉ and S₁₃ are open. The stator winding U₁ is therefore connected in series with the stator winding U₂. The stator winding V₁ is connected in series with the stator winding V₂, and the stator winding W₁ is connected in series with the stator winding W₂. If, on the other hand, a parallel connection of the respective stator windings of a phase is achieved, a signal invS is output by the control unit 22. As a result, the switches S₁, S₃, S₆, S₁₁ and S₁₃ are closed, while the switches S₂, S₇ and S₁₂ are open. The stator windings U₁ and U₂ are therefore connected in parallel. The stator windings V₁ and V₂ are connected in parallel, and the stator windings W₁ and W₂ are also connected in parallel. S₄, S₇ and S₁₄ are closed, while the switches S₅, S₁₀, and S₁₅ are open. As a

Depending on the configurations described above, different voltages can therefore be made available by the configuration circuit 18. These said voltages are transmitted to the rectifier stage 20. The rectifier stage 20 is also controlled by the electronic control unit 22, i.e., to output the high voltage V++ by outputting the signal H, and to provide the low voltage +V by outputting the signal L. The thyristor T₁ is therefore responsible for the rectification of the positive half wave of high voltage provided due to a series connection of the stator windings U₁ and U₂, while the thyristor T₂ is responsible for the rectification of the positive half wave of the low voltage provided due to the parallel connection of the stator windings U₁ and U₂. Likewise, the thyristor T₃ is responsible for the rectification of the high voltage due to the series connection of V₁ and V₂, while the thyristor T₄ is responsible for the rectification of the low voltage when the stator windings V₁ and V₂ are connected in parallel. The thyristor T₅ serves to rectify the high voltage due to the series connection of the stator windings W₁ and W₂. The thyristor T₆ is provided for the rectification of low voltage when the stator windings W₁ and W₂ are connected in parallel. The diode D₁ serves to rectify the negative half wave of the stator phase U. The diode D₂ is provided to rectify the negative half wave of the stator phase V. The diode D₃ serves to rectify the negative half wave of the stator phase W.

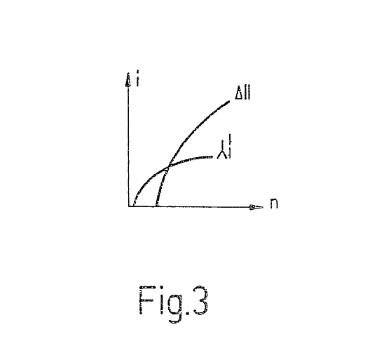

A diagram is shown in FIG. 3 that depicts two different current curves (i) as a function of rotor frequency (n) for various configurations. It shows, as examples, a parallel connection of the stator windings of a phase when a delta connection exists, and a series connection of the stator windings of a phase when a star connection exists.

The preceding description of the exemplary embodiments according to the present invention serves an illustrative purpose only and is not intended to limit the invention. Various changes and modifications are possible within the scope of the invention, without leaving the scope of the invention or its equivalents.

What is claimed is:

1. An apparatus having an alternating-current generator (10) for generating various output voltages, whereby the alternating-current generator (10) comprises a rotor (12) and a stator (14) having a plurality of stator windings (16), and the stator windings (16) are configured in a certain fashion to generate an output voltage,
wherein the configuration of the connections of the stator windings (16) is changeable by means of a configuration circuit (18) to generate various output voltages.

2. The apparatus according to claim 1,
wherein the configuration circuit (18) is combined with a switchable rectifier stage (20).

3. The apparatus according to claim 1 or 2,
wherein a control unit (22) is provided to control the configuration circuit (18) and the switchable rectifier stage (20).

4. The apparatus according to one of the preceding claims,
wherein a stator (14) having three phases (U, V, W) is provided.

5. The apparatus according to one of the preceding claims,
wherein the configuration of the three phases (U, V, W) of the stator (14) is changeable in such a fashion that, alternatively, a star connection or a delta connection exists.

6. The apparatus according to one of the preceding claims,
wherein each phase (U, V, W) of the stator (14) comprises two stator windings (16).

7. The apparatus according to one of the preceding claims,
wherein the configuration of the connections of the stator windings (16) of a phase (U, V, W) is changeable in such a fashion that, alternatively, a series connection or a parallel connection exists.

8. The apparatus according to one of the preceding claims,
wherein the rotor (12) is of the coil type.

9. The apparatus according to one of the preceding claims,
wherein the rotor (12) is a permanent magnet.

10. The apparatus according to one of the preceding claims,
wherein the configuration circuit (18) comprises bidirectional switching elements (Sₙ).

11. The apparatus according to one of the preceding claims,
wherein a bidirectional switching element (Sₙ) is achieved by means of two parallel thyristors.

12. The apparatus according to one of the preceding claims,
wherein a bidirectional switching element (Sₙ) is achieved by means of a series connection of two MOSFETs.

13. The apparatus according to one of the preceding claims,
wherein the switchable rectifier stage (20) comprises thyristors (Tₙ) and diodes (Dₙ).

14. The apparatus according to one of the preceding claims,
wherein the control unit (22) monitors the phase response of the alternating-current generator (10).

15. The apparatus according to one of the preceding claims,
wherein the control unit (22) monitors the output voltage.

16. The apparatus according to one of the preceding claims,
wherein the configuration circuit (18) and/or the switchable rectifier stage (20) are achieved as an integrated circuit.

17. A method for generating various output voltages having an alternating-current generator (10), whereby the alternating-current generator (10) comprises a rotor (12) and a stator (14) having a plurality of stator windings (16), and the stator windings (16) are configured in a certain fashion to generate an output voltage,
wherein the configuration of the connections of the stator windings (16) are changed by means of a configuration circuit (18) to generate various output voltages.

18. The method according to claim 17,
wherein the configuration circuit (18) and a switchable rectifier stage (20) combined with the configuration circuit (18) are controlled by a control unit (22).

19. The method according to claim 17 or 18,
wherein three phases (U, V, W) are generated by the stator (16).

20. The method according to one of the claims 17 through 19,
wherein the configuration of the three phases (U, V, W) of the stator (14) are changed in such a fashion that, alternatively, a star connection or a delta connection exists.

21. The method according to one of the claims 17 through 20,
wherein, in the case of two stator windings (16) per phase (U, V, W) of the stator (14), the configuration of the stator windings (16) of one phase (U, V, W) are changed in such a fashion that, alternatively, a series connection or a parallel connection exists.

22. The method according to one of the claims 17 through 21,
wherein the phase response of the alternating-current generator (10) is monitored by the control unit (22).

23. The method according to one of the claims 17 through 22,
wherein the output voltages are monitored by the control unit (22).
